(19) United States
(12) Patent Application Publication
(10) Pub. No.: US 2026/0045662 A1
(43) Pub. Date: Feb. 12, 2026

(54) BATTERY WIRING MODULE

(71) Applicant: SUMITOMO WIRING SYSTEMS, LTD., Mie (JP)

(72) Inventors: Hiroshi SATO, Mie (JP); Masami SUZUKI, Mie (JP)

(21) Appl. No.: 18/995,838

(22) PCT Filed: Jul. 13, 2023
(86) PCT No.: PCT/JP2023/025871

§ 371 Date: Jan. 17, 2025

(30) Foreign Application Priority Data
Aug. 1, 2022 (JP) 2022-122700

(51) Int. Cl. H01M 50/569; H01M 50/204; H01M 50/242; H01M 50/289; H01M 50/298; H01M 50/507

(52) U.S. Cl. CPC H01M 50/569; H01M 50/204; H01M 50/242; H01M 50/289; H01M 50/298; H01M 50/507

(57) ABSTRACT

A case (22) includes a first divided case (31) and a second divided case (32) installed in parallel along an X direction. The first divided case (31) includes a first coupling portion (60). The second divided case (32) includes a second coupling portion (70) to be coupled to the first coupling portion (60). A coupling direction of the first coupling portion (60) and the second coupling portion (70) is a direction along an assembly direction (D) of the first divided case (31) and the second divided case (32) with a battery.

### TECHNICAL FIELD

The present disclosure relates to a battery wiring module.

### BACKGROUND

For example, as disclosed in Patent Document 1, a battery wiring module is mounted on a high-voltage battery installed as a power supply for travel drive in a vehicle such as an electric vehicle or a hybrid vehicle. The battery wiring module is provided with wires to be electrically connected to the battery and a case for accommodating the wires. The case of the battery wiring module includes a plurality of divided cases arranged in a parallel installation direction of a plurality of battery cells constituting the battery. According to this configuration, deformation caused by the thermal expansion of the battery and manufacturing tolerances of components can be absorbed by making the respective divided cases displaceable in the parallel installation direction. Thus, connection reliability between the battery and the battery wiring module is improved.

Each divided case includes a coupling portion for coupling the adjacent divided cases to each other. In the battery wiring module of Patent Document 1, a coupling direction of the coupling portions is along the parallel installation direction of the divided cases. That is, the divided cases are coupled to each other by fitting one coupling portion to the other coupling portion along the parallel installation direction of the divided cases.

### PRIOR ART DOCUMENT

### Patent Document

Patent Document 1: JP 2015-002164 A

### SUMMARY OF THE INVENTION

### Problems to be Solved

The present inventors studied how to improve the assemblability of a case including a plurality of divided cases with a battery in a battery wiring module as described above.

The present disclosure aims to provide a battery wiring module capable of improving the assemblability of a case.

### Means to Solve the Problem

The present disclosure is directed to a battery wiring module mountable on a battery, the battery wiring module being provided with a wire to be electrically connected to the battery and a case for accommodating the wire, the case including a plurality of divided cases installed in parallel, one of a pair of the adjacent divided cases including a first coupling portion, the other of the pair of divided cases including a second coupling portion to be coupled to the first coupling portion, and a coupling direction of the first and second coupling portions being a direction along an assembly direction of the case with the battery.

### Effect of the Invention

The battery wiring module of the present disclosure can exhibit an effect of improving the assemblability of the case.

### BRIEF DESCRIPTION OF THE DRAWINGS

FIG. 1 is a schematic plan view of a battery wiring module of an embodiment.

FIG. 2 is a schematic side view of the battery wiring module of the embodiment.

FIG. 3 is a perspective view showing a part of a case in the battery wiring module of the embodiment.

FIG. 4 is an exploded perspective view showing the part of the case in the battery wiring module of the embodiment.

### DETAILED DESCRIPTION TO EXECUTE THE INVENTION

### Description of Embodiments of Present Disclosure

First, embodiments of the present disclosure are listed and described.
[1] The battery wiring module of the present disclosure is mountable on a battery and provided with a wire to be electrically connected to the battery and a case for accommodating the wire, the case including a plurality of divided cases installed in parallel, one of a pair of the adjacent divided cases, out of the plurality of divided cases, including a first coupling portion, the other of the pair of divided cases including a second coupling portion to be coupled to the first coupling portion, and a coupling direction of the first and second coupling portions being a direction along an assembly direction of the case with the battery.

According to this configuration, an operation of assembling the targeted divided case of the case with the battery can be completed simultaneously with an operation of coupling the first and second coupling portions. Therefore, the assemblability of the case with the battery can be improved.
[2] In [1] described above, the coupling direction may be a direction intersecting a parallel installation direction of the plurality of divided cases.

According to this configuration, the operation of assembling the targeted divided case of the case with the battery can be completed simultaneously with the operation of coupling the first and second coupling portions along a direction intersecting the parallel installation direction of the plurality of divided cases.
[3] In [1] or [2] described above, the battery may include a plurality of battery cells installed in parallel along the parallel installation direction of the plurality of divided cases.

According to this configuration, the battery can be elongated in the parallel installation direction of the battery cells. A dimensional change due to the thermal expansion of the battery tends to become larger in the parallel installation direction of the elongated battery cells. Therefore, according to a configuration in which the plurality of divided cases are installed in parallel along the parallel installation direction of the battery cells, the respective divided cases are displaced actively, so to speak, to fill up gaps therebetween along the parallel installation direction of the respective divided cases. In this way, deformation due to the thermal expansion of the battery can be more effectively absorbed.
[4] In any one of [1] to [3] described above, the first coupling portion may be in the form of a hole, and the second coupling portion may be an extending portion to be inserted into the first coupling portion along the coupling direction.

According to this configuration, the operation of assembling the targeted divided case of the case with the battery can be completed simultaneously with an operation of inserting the second coupling portion into the hole-like first coupling portion and coupling these coupling portions. As a result, the assemblability of the divided cases can be suitably improved.
[5] In any one of [1] to [4] described above, a displacement allowing portion for allowing a relative displacement of the second coupling portion with respect to the first coupling portion in the parallel installation direction of the plurality of divided cases may be provided between the first and second coupling portions.

According to this configuration, a relative displacement of the second coupling portion with respect to the first coupling portion in the parallel installation direction of the divided cases is allowed by the displacement allowing portion. Therefore, the respective divided cases can be actively displaced along the parallel installation direction.
[6] In any one of [1] to [5] described above, each of the plurality of divided cases may include a busbar holding portion for holding a busbar for forming an electrically conductive path together with the wire, and one of the first and second coupling portions and the busbar holding portion may be provided at the same position in the parallel installation direction of the plurality of divided cases.

According to this configuration, the first or second coupling portion and the busbar holding portion are not at different positions in the parallel installation direction of the divided cases. This can contribute to the size reduction of the case in the parallel installation direction of the divided cases.

### Details of Embodiment of Present Disclosure

A specific example of a battery wiring module of the present disclosure is described below with reference to the drawings. For the convenience of description, some components may be shown in an exaggerated or simplified manner in each drawing. Further, a dimension ratio of each part may be different in each drawing. Note that “facing each other” in this specification indicates that surfaces or members are at positions in front of each other, and means not only a case where the surfaces or members are at positions perfectly in front of each other, but also a case where the surfaces or members are partially in front of each other. Further, “facing each other” in this specification means both a case where another member different from two parts is interposed between the two parts and a case where nothing is interposed between the two parts.

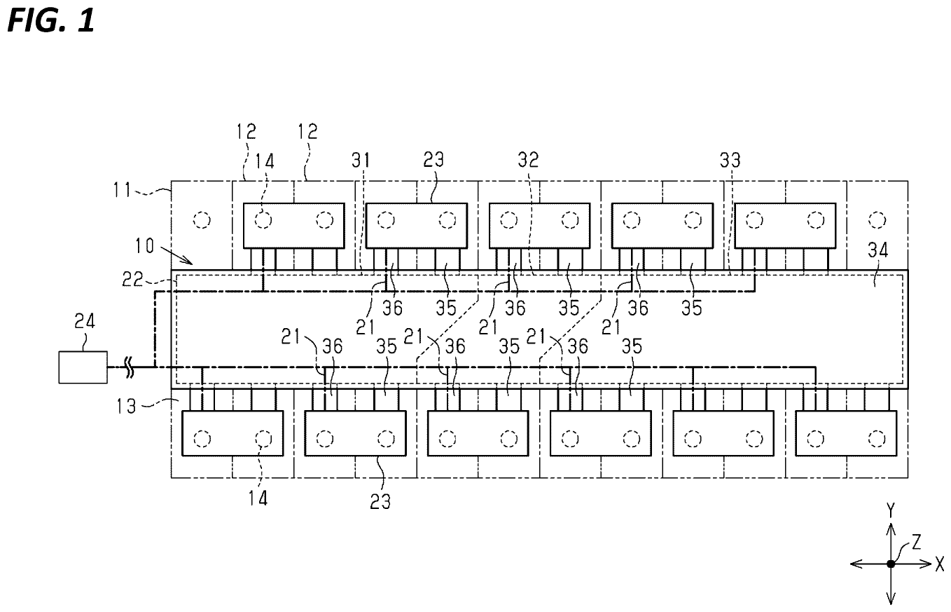

As shown in FIG. 1, a battery wiring module 10 of an embodiment is, for example, mounted on a battery 11 to be installed in an electric vehicle, a hybrid vehicle or the like. The battery 11 is, for example, a secondary battery. The battery 11 supplies power to a travel motor of an unillustrated vehicle. Further, the battery 11 receives the supply of power from the travel motor or a power generation motor according to a charged state or a driving state of the vehicle.

The battery 11 includes a plurality of battery cells 12. The battery 11 has, for example, a substantially rectangular parallelepiped shape by arranging the plurality of battery cells 12 in one direction. In the following description, an arrangement direction of the battery cells 12 is referred to as an X direction and a direction orthogonal to the X direction is referred to a Y direction. Further, a Z direction orthogonal to the X direction and the Y direction is a vertical direction, and the battery wiring module 10 is mounted on an upper side of the battery 1. That is, the battery 11 has a module mounting surface 13, on which the battery wiring module 10 is mounted, on a side surface on the upper side.

Each battery cell 12 includes two battery terminals 14. One of the two battery terminals 14 is a positive electrode terminal and the other is a negative electrode terminal. When the respective battery cells 12 are arranged in the X direction, the two battery terminals 14 are arranged along the Y direction on the upper surface of the battery cell 12.

### Configuration of Battery Wiring Module 10

The battery wiring module 10 is provided with a plurality of wires 21 to be electrically connected to the battery 11 and a case 22 for accommodating the respective wires 21. Further, the battery wiring module 10 is, for example, provided with a plurality of busbars 23 supported on the case 22. A plurality of the busbars 23 are, for example, arranged side by side in the X direction on both sides in the Y direction of the case 22. Each busbar 23 connects the battery terminals 14 adjacent in the X direction to each other. The busbar 23 is, for example, connected to the battery terminals 14 by welding. Each busbar 23 is electrically connected to the corresponding wire 21. The busbar 23 forms an electrically conductive path together with the wire 21. The wire 21 is, for example, a voltage detection wire for detecting a voltage of the busbar 23. Each wire 21 is connected to a connector 24 for connection to an unillustrated voltage detection device.

### Configuration of Case 22

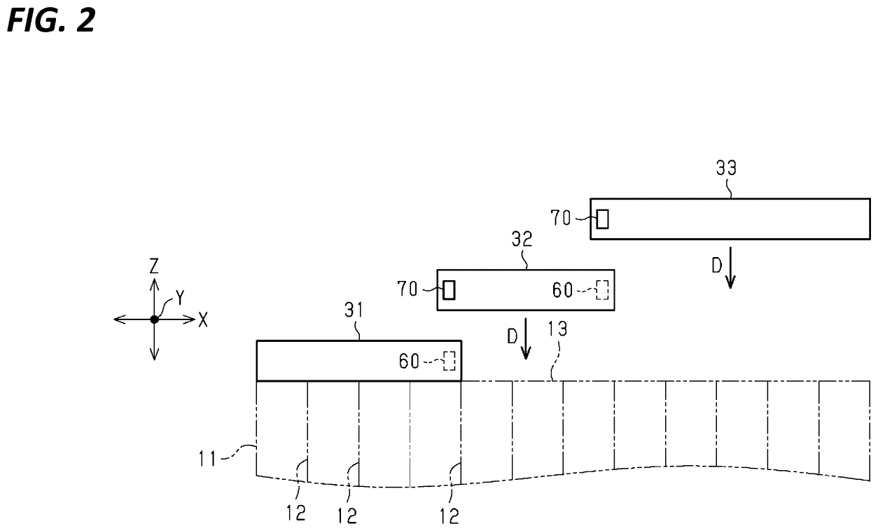

The case 22 is provided with a first divided case 31, a second divided case 32, a third divided case 33 and a cover 34. The first divided case 31, the second divided case 32, the third divided case 33 and the cover 34 are made of an insulating material such as synthetic resin. The first, second and third divided cases 31, 32 and 33 are installed in parallel in the X direction. The second divided case 32 is arranged between the first and third divided cases 31, 33 in the X direction. Note that the cover 34 is divided to correspond to the respective first, second and third divided cases 31, 32 and 33. As shown in FIG. 2, each of the first, second and third divided cases 31, 32 and 33 is mounted on the module mounting surface 13 of the battery 11 from above in an assembly direction D along the Z direction.

As shown in FIG. 1, the case 22 includes first busbar holding portions 35 and second busbar holding portions 36. The first and second busbar holding portions 35, 36 have mutually different shapes. A plurality of the first busbar holding portions 35 and a plurality of the second busbar holding portions 36 are alternately arranged in the X direction. Two rows of the first and second busbar holding portions 35, 36 are provided to correspond to two rows of the busbars 23 arranged in the X direction. A pair of the first and second busbar holding portions 35, 36 adjacent in the X direction hold one busbar 23. Each busbar 23 is provided over the first and second busbar holding portions 35, 36 adjacent in the X direction.

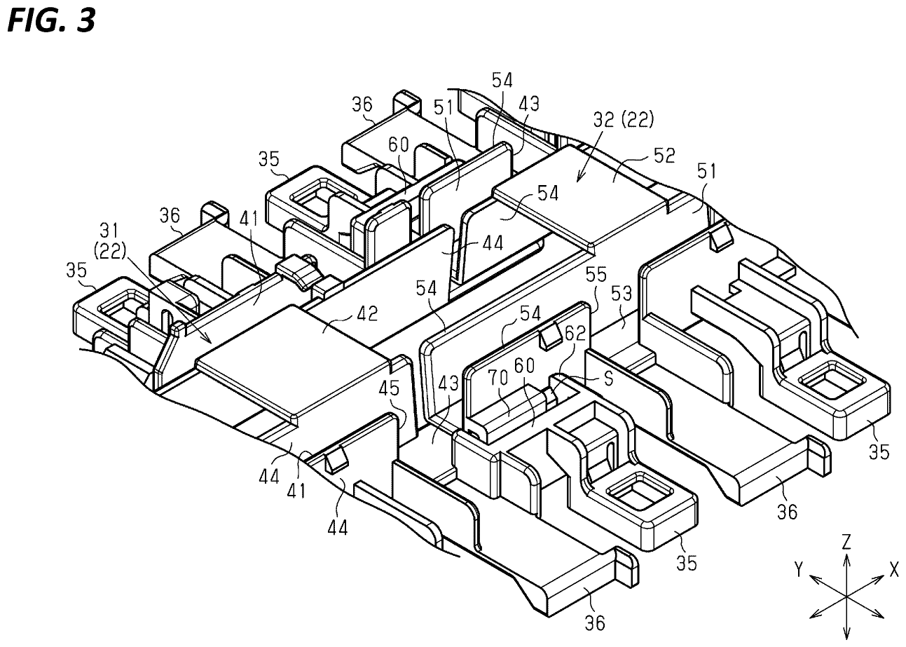

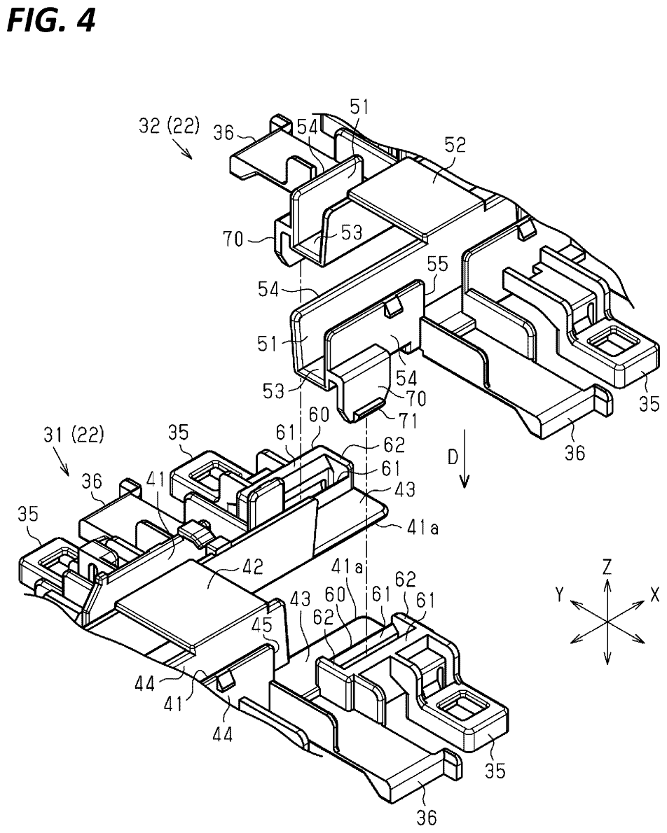

FIGS. 3 and 4 show a part of the case 22 including a coupling part of the first and second divided cases 31, 32. As shown in FIGS. 3 and 4, the first divided case 31 includes a pair of first wire accommodating portions 41 extending in the X direction. The pair of first wire accommodating portions 41 are arranged apart from each other in the Y direction. Further, the first divided case 31 includes a first bridge portion 42 coupling the pair of first wire accommodating portions 41 arranged in the Y direction.

Each first wire accommodating portion 41 includes a bottom wall 43 and a pair of side walls 44 facing each other in the Y direction. The lower surface of the bottom wall 43 is facing the module mounting surface 13 in the Z direction. Each side wall 44 extends upward from the bottom wall 43. The wires 21 are accommodated between the pair of side walls 44 in the Y direction.

The second divided case 32 includes a pair of second wire accommodating portions 51 extending in the X direction. The pair of second wire accommodating portions 51 are arranged apart from each other in the Y direction. With the first and second divided cases 31, 32 assembled with each other, the first and second wire accommodating portions 41, 51 are linearly arranged along the X direction. The second divided case 32 includes a second bridge portion 52 coupling the pair of second wire accommodating portions 51 arranged in the Y direction.

Each second wire accommodating portion 51 includes a bottom wall 53 and a pair of side walls 54 facing each other in the Y direction. The lower surface of the bottom wall 53 is facing the module mounting surface 13 in the Z direction. Each side wall 54 extends upward from the bottom wall 53. The wires 21 are accommodated between the pair of side walls 54 in the Y direction.

The first and second busbar holding portions 35, 36 extend outward in the Y direction from each of the first and second wire accommodating portions 41, 51. An opening 45 is provided at a position corresponding to the second busbar holding portion 36 in the side wall 44 of the first wire accommodating portion 41. The wire 21 is pulled out to outside in the Y direction through the opening 45 from the inside of the first wire accommodating portion 41.

Further, an opening 55 is provided at a position corresponding to the second busbar holding portion 36 in the side wall 54 of the second wire accommodating portion 51. The wire 21 is pulled out to outside in the Y direction through the opening 55 from the inside of the second wire accommodating portion 51. Open upper sides of the first and second wire accommodating portions 41, 51 are covered by the cover 34.

Note that the pair of first wire accommodating portions 41 and the pair of second wire accommodating portions 51 are provided apart in the Y direction, for example, to provide another member in a central part of the battery 11 in the Y direction or to provide a space for providing clearances to another member. An example of the other member is an explosion-proof valve.

### Configurations of First Coupling Portion 60 and Second Coupling Portion 70

The first divided case 31 includes a first coupling portion 60. The second divided case 32 includes a second coupling portion 70 to be coupled to the first coupling portion 60. For example, as shown in FIG. 4, the first coupling portion 60 is in the form of a hole and the second coupling portion 70 is an extending portion to be inserted into the first coupling portion 60.

The first coupling portion 60 is, for example, provided in an end part 41a in the X direction of the first wire accommodating portion 41. The first wire accommodating portion 41 does not include the respective side walls 44 in the end part 41a. The first coupling portion 60 is connected to the bottom wall 43 in the end part 41a. Further, the first coupling portion 60 is provided between the bottom wall 43 and the first busbar holding portion 35 in the end part 41a.

The first coupling portion 60 includes a pair of first wall portions 61 facing each other in the Y direction and a pair of second wall portions 62 coupling the pair of first wall portions 61. The pair of second wall portions 62 are facing each other in the X direction. The second coupling portion 70 is inserted into a part surrounded by the respective first wall portions 61 and the respective second wall portions 62. The first busbar holding portion 35 extends from the first wall portion 61 on an outer side in the Y direction, out of the pair of first wall portions 60. That is, the first coupling portion 60 and the first busbar holding portion 35 are provided at the same position in the X direction.

The second coupling portion 70 is provided in one end part in the X direction of the second wire accommodating portion 51. The second coupling portion 70 extends downward in the Z direction from the side wall 54 on an outer side in the Y direction of the second wire accommodating portion 51. A locking portion 71 is provided on a lower end part of the second coupling portion 70. The second coupling portion 70 is inserted into the first coupling portion 60 along the Z direction. The locking portion 71 is hooked to one first wall portion 61 of the first coupling portion 60 in the Z direction. That is, a coupling direction of the first and second coupling portions 60, 70 is the Z direction along the assembly direction D of the second divided case 32 with the battery 11. By locking the locking portion 71 of the second coupling portion 70 to the first wall portion 61 of the first coupling portion 60, the second divided case 32 is assembled with the first divided case 31. Note that, with the first and second coupling portions 60, 70 coupled, the bottom wall 43 in the end part 41a of the first wire accommodating portion 41 and the bottom wall 53 of the second wire accommodating portion 51 overlap each other in the Z direction.

A dimension in the X direction of the second coupling portion 70 is set to be smaller than a hole dimension in the X direction of the first coupling portion 60. In this way, as shown in FIG. 3, a gap is provided between the first and second coupling portions 60, 70 in the X direction with the first and second coupling portions 60, 70 coupled. That is, a displacement allowing portion S for allowing a relative displacement of the second coupling portion 70 with respect to the first coupling portion 60 in the X direction is provided between the first and second coupling portions 60, 70.

Note that the third divided case 33 has substantially the same configuration as the first and second divided cases 31, 32. In particular, the third divided case 33 includes a pair of wire accommodating portions (not shown) similar to the first and second wire accommodating portions 41, 51. These wire accommodating portions are linearly arranged with the first and second wire accommodating portions 41, 51 along the X direction.

Further, a coupling structure of the second and third divided cases 32, 33 is similar to that of the first and second divided cases 31, 32 described above. That is, as shown in FIG. 2, a first coupling portion 60 is provided in an end part opposite to the end part provided with the second coupling portion 70 in the second divided case 32. A second coupling portion 70 provided in an end part in the X direction of the third divided case 33 is coupled to the first coupling portion 60 of the second divided case 32 in the Z direction.

Functions of this embodiment are described.

The first, second and third divided cases 31, 32 and 33 are configured to be displaceable in the parallel installation direction of these, i.e. in the X direction. In this way, deformation due to the thermal expansion of the battery 11 and manufacturing tolerances of components can be absorbed by displacements of the respective divided cases 31, 32 and 33 in the X direction. As a result, for example, connection reliability between the wires 21 and the busbars 23 can be improved.

As shown in FIG. 2, in mounting the case 22 on the module mounting surface 13 of the battery 11, the first divided case 31 is first mounted on the module mounting surface 13. Thereafter, the second divided case 32 is mounted on the module mounting surface 13 from above in the assembly direction D along the Z direction. The coupling direction of the first coupling portion 60 of the first divided case 31 and the second coupling portion 70 of the second divided case 32 is a direction along the Z direction. Thus, the second coupling portion 70 of the second divided case 32 can be inserted and coupled to the first coupling portion 60 of the first divided case 31 along with an operation of mounting the second divided case 32 on the module mounting surface 13.

Thereafter, the third divided case 33 is mounted on the module mounting surface 13 from above in the assembly direction D along the Z direction. The coupling direction of the first coupling portion 60 of the second divided case 32 and the second coupling portion 70 of the third divided case 33 is a direction along the Z direction. Thus, the second coupling portion 70 of the third divided case 33 can be inserted and coupled to the first coupling portion 60 of the second divided case 32 along with an operation of mounting the third divided case 33 on the module mounting surface 13.

Effects of this embodiment are described.
(1) The coupling direction of the first coupling portion 60 and the second coupling portion 70 is a direction along the assembly direction D of each divided case 31, 32, 33 with the battery 11. According to this configuration, the operation of assembling the second and third divided cases 32, 33 with the battery 11 can be completed simultaneously with the operation of coupling the first and second coupling portions 60, 70. Therefore, the assemblability of the case 22 with the battery 11 can be improved.
(2) The coupling direction of the first coupling portion 60 and the second coupling portion 70 is along the Z direction intersecting the parallel installation direction of the plurality of divided cases 31, 32 and 33. According to this configuration, the operation of assembling the second and third divided cases 32, 33 with the battery 11 can be completed simultaneously with the operation of coupling the first and second coupling portions 60, 70 in the Z direction intersecting the parallel installation direction of the plurality of divided cases 31, 32 and 33.
(3) The battery 11 includes the plurality of battery cells 12 installed in parallel in the parallel installation direction of the plurality of divided cases 31, 32 and 33. According to this configuration, the battery 11 can be elongated in the parallel installation direction of the battery cells 12. A dimensional change due to the thermal expansion of the battery 11 tends to become larger in the parallel installation direction of the elongated battery cells 12. Therefore, according to the configuration in which the plurality of divided cases 31, 32, 33 are installed in parallel along the parallel installation direction of the battery cells 12, deformation due to the thermal expansion of the battery 11 can be more effectively absorbed by displacements of the respective divided cases 31, 32 and 33 in the parallel installation direction.
(4) The first coupling portion 60 is in the form of a hole, and the second coupling portion 70 is an extending portion to be inserted into the first coupling portion 60 along the Z direction, which is the coupling direction. According to this configuration, the operation of assembling the second and third divided cases 32, 33 with the battery 11 can be completed simultaneously with the operation of inserting and coupling the second coupling portion 70 to the hole-like first coupling portion 60. As a result, the assemblability of the case 22 can be suitably improved.
(5) The displacement allowing portion S for allowing a relative displacement of the second coupling portion 70 with respect to the first coupling portion 60 in the parallel installation direction of the respective divided cases 31, 32 and 33 is provided between the first and second coupling portions 60, 70. According to this configuration, a relative displacement of the second coupling portion 70 with respect to the first coupling portion 60 in the parallel installation direction of the respective divided cases 31, 32 and 33 is allowed by the displacement allowing portion S. Therefore, displacements in the parallel installation direction of the respective divided cases 31, 32 and 33 can be allowed by the displacement allowing portion S.
(6) Each divided case 31, 32, 33 includes the first and second busbar holding portions 35, 36 for holding the busbars 23 for forming the electrically conductive paths together with the wires 21. The first coupling portion 60 and the first busbar holding portion 35 are provided at the same position in the parallel installation direction of the respective divided cases 31, 32 and 33. According to this configuration, the first coupling portion 60 and the first busbar holding portion 35 are not at different positions in the parallel installation direction of the respective divided cases 31, 32 and 33. This can contribute to the size reduction of the case 22 in the parallel installation direction of the respective divided cases 31, 32 and 33.

### Modifications

This embodiment can be modified and carried out as follows. This embodiment and the following modifications can be carried out in combination without technically contradicting each other.
Although the first coupling portion 60 and the first busbar holding portion 35 are provided at the same position in the X direction in the above embodiment, there is no limitation to this. For example, in the second divided case 32 or the third divided case 33, the second coupling portion 70 and the first busbar holding portion 35 may be provided at the same position in the X direction. In this case, in the first divided case 31 or the second divided case 32, the first busbar holding portion 35 provided at the same position as the first coupling portion 60 in the X direction can be omitted.

A convex-concave relationship in the coupling structure of the first and second coupling portions 60, 70 may be reversed from that of the above embodiment. That is, the second coupling portion 70 may be in the form of a hole and the first coupling portion 60 may be an extending portion extending upward. Also by this configuration, the first coupling portion 60 can be inserted and coupled to the second coupling portion 70 along with the operation of assembling each divided case 31, 32, 33 with the battery 11.
The parallel installation direction of the divided cases 31, 32 and 33 may not necessarily coincide with the parallel installation direction of the battery cells 12.
The assembly direction D of the divided cases 31, 32 and 33 is not limited to the direction of the above embodiment, but may be a direction inclined with respect to the Z direction or a direction along the X direction. In this case, the coupling direction of the first and second coupling portions 60, 70 is changed as appropriate according to the assembly direction D of the divided cases 31, 32 and 33.
The embodiment and the modifications disclosed this time are illustrative in all aspects and the present invention is not limited to these illustrations. That is, the scope of the present invention is represented by claims and intended to include all changes in the scope of claims and in the meaning and scope of equivalents.

### LIST OF REFERENCE NUMERALS

10 battery wiring module
11 battery
12 battery cell
13 module mounting surface
14 battery terminal
21 wire
22 case
23 busbar
24 connector
31 first divided case (divided case)
32 second divided case (divided case)
33 third divided case (divided case)
34 cover
35 first busbar holding portion (busbar holding portion)
36 second busbar holding portion (busbar holding portion)
41 first wire accommodating portion
41a end part
42 first bridge portion
43 bottom wall
44 side wall
45 opening
51 second wire accommodating portion
52 second bridge portion
53 bottom wall
54 side wall
55 opening
60 first coupling portion
61 first wall portion
62 second wall portion
70 second coupling portion (extending portion)
71 locking portion
D assembly direction
S displacement allowing portion

1. A battery wiring module mountable on a battery, comprising:
a wire to be electrically connected to the battery; and
a case for accommodating the wire,
the case including a plurality of divided cases installed in parallel,
one of a pair of the adjacent divided cases, out of the plurality of divided cases, including a first coupling portion, the other of the pair of divided cases including a second coupling portion to be coupled to the first coupling portion,
a coupling direction of the first and second coupling portions being a direction along an assembly direction of the case with the battery,
each of the plurality of divided cases including a wire accommodating portion formed by a bottom wall and a pair of side walls and a busbar holding portion for holding a busbar for forming an electrically conductive path together with the wire,
the first coupling portion being in the form of a hole, the first coupling portion including a pair of first wall portions and a pair of second wall portions coupling the pair of first wall portions,
the busbar holding portion extending from one of the pair of first wall portions of the first coupling portion, and
the second coupling portion being an extending portion extending along the coupling direction from one of the pair of side walls of the wire accommodating portion.

2. The battery wiring module of claim 1, wherein the coupling direction is a direction intersecting a parallel installation direction of the plurality of divided cases.

3. The battery wiring module of claim 1, wherein the battery includes a plurality of battery cells installed in parallel along the parallel installation direction of the plurality of divided cases.

4. (canceled)

5. The battery wiring module of claim 1, wherein a displacement allowing portion for allowing a relative displacement of the second coupling portion with respect to the first coupling portion in the parallel installation direction of the plurality of divided cases is provided between the first and second coupling portions.

6. (canceled)
